(19) United States
(12) Patent Application Publication
(10) Pub. No.: US 2005/0097530 A1
(43) Pub. Date: May 5, 2005

(54) Template compilation method

(75) Inventors: Shinobu Asao, Osaka (JP); Koji Nakajima, Nara (JP); Hirohisa Tanaka, Osaka (JP)

Correspondence Address: Jack Q. Lever, Jr.;McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/914,108

(22) Filed: Aug. 10, 2004

(30) Foreign Application Priority Data
Nov. 5, 2003 (JP) 2003-375776

(51) Int. Cl. G06F 9/45

(52) U.S. Cl. 717/140

(57) ABSTRACT

In an identical function definition generation determining step of a template compilation method, dependency between a function definition code and a template parameter is analyzed, and when there is no dependency, a common function is defined and a plurality of function definitions obtained before defining the common function are deleted in a function definition sharing step. Thereafter, a function call obtained before defining the common function is replaced with a call of the common function in a function call replacing step. Accordingly, among a plurality of function definition codes generated from a template, function definition codes generated as the identical code are shared, so as to reduce the code size that generally increases due to template facilities.

### BACKGROUND OF THE INVENTION

The present invention relates to a compilation method for converting a program described with a high-level language with template facilities into object codes.

In recent development of software, the scale of a program has become large, and therefore, an object-oriented language with high maintainability and reusability is regarded useful.

A typical example of the object-oriented language is the C++ language. The C++ language has template facilities and is usable for generic programming with high maintainability and reusability. Also, a standard template library designated as STL is generally provided to a compiler, and programming using the template facilities is expected to increase in the future.

FIG. 12 shows examples of codes generated through compilation of a C++ program by using the template facilities.

As shown in source codes (a) and (b) of FIG. 12, templates respectively representing a class group and a function group are defined in the C++ language, and thus, function definitions can be easily generated by giving template parameters. In a source code (c), temperate parameters int and long are given to the template of the source code (a) or (b), so as to generate A<int> type and A<long> type classes and functions A<int>::f and A<long>::f with a return value of a void type and arguments of an int type and a long type and to define an object ‘a’ of the A<int> type and an object ‘b’ of the A<long> type. In a source code (d), generated member functions A<int>::f and A<long>::f are called.

The generated codes shown in FIG. 12 result from the compilation performed on the source codes by a conventional compilation method. It is understood that definition codes (f) and (g) of the functions A<int>::f and A<long>::f generated by giving the parameters int and long to the template are generated and that the definition codes (f) and (g) are called by a call statement in a definition code (e) of a function h. At this point, a label corresponding to the operand of the call statement is a label indicating the starting address of the function definition. In this manner, a plurality of classes and functions can be easily generated by defining a template and giving template parameters.

In the conventional compilation, when different template parameters are given to a template, functions (including a static function, an external function and a virtual or non-virtual member function) corresponding to the respective parameter values are always generated as codes with different definitions. For example, in FIG. 12, the definition code (f) is generated correspondingly to the template parameter int and the definition code (g) is generated correspondingly to the template parameter long. Therefore, the whole code size is largely increased in accordance with “the code size of function definitions generated from a template”×“the number of kinds of template parameters”.

However, with respect to a function generated from a template, a different code is not always generated when a template parameter is different but an identical code may be generated. For example, in FIG. 12, although the functions A<int>::f and A<long>::f are given different template parameters, the generated definition codes (f) and (g) are identical to each other.

As conventional technique to prevent such increase of the code size, for example, Japanese Laid-Open Patent Publication No. 9-231077 describes a program description method in which a common part of a program is separated, as an implementation class with no specified type, from an interface class with a specified type having a template with a dummy argument.

In this conventional technique, however, a programmer is forced to intentionally describe a common part of a program as an implementation class with no specified type, which increases the burden of the programmer.

### SUMMARY OF THE INVENTION

An object of the invention is providing a template compilation method in which the code size increased due to template facilities is reduced without making a programmer conscious of optimum program description.

In order to achieve the object, according to the present invention, two or more function definition codes generated as an identical code among a plurality of function definition codes generated from a template are automatically determined by a CPU, so as to share the two or more identical function definition codes.

Specifically, the template compilation method of this invention for converting an input program described with a high-level language with template facilities into object codes, includes an identical function definition generation determining step of determining whether or not identical function definitions are generated, as definitions of a plurality of functions included in the input program, from a template by using different template parameters; a function definition sharing step, performed when it is determined that the identical function definitions are generated in the identical function definition generation determining step, of replacing the definitions of the plurality of functions generated as the identical function definitions with one common function definition; and a function call replacing step, performed when the common function definition is replaced in the function definition sharing step, of replacing calls of the plurality of functions obtained before replacing the common function definition with a call of the common function definition.

In an aspect of the template compilation method of this invention, it is analyzed in the identical function definition generation determining step whether or not any of the definitions of the plurality of functions uses a function template as the template and includes a portion depending upon a template parameter in a function defining portion thereof.

In another aspect of the template compilation method of this invention, in the identical function definition generation determining step, when it is determined as a result of analysis that any of the definitions of the plurality of functions using a function template as the template includes no portion depending upon a template parameter in the function defining portion thereof, nondependent function information composed of at least a file name, a template function name and an instantiated function name is generated.

In another aspect of the template compilation method of this invention, it is analyzed in the identical function definition generation determining step whether or not any of the definitions of the plurality of functions uses a class template as the template and includes a portion depending upon a template parameter in a member function defining portion thereof.

In another aspect of the template compilation method of this invention, in the identical function definition generation determining step, when it is determined as a result of analysis that any of the definitions of the plurality of functions using a class template as the template includes no portion depending upon the template parameter in the member function defining portion thereof, nondependent function information composed of at least a file name, a template function name and an instantiated function name is generated.

In another aspect of the template compilation method of this invention, it is analyzed in the identical function definition generation determining step whether or not any of the definitions of the plurality of functions uses a function template as the template and includes type conversion depending upon a template parameter in a function defining portion thereof, whether or not any of the definitions of the plurality of functions includes a function call using an argument depending upon a template parameter, and whether or not there already exists a function definition instantiated with a template parameter with an identical type size.

In another aspect of the template compilation method of this invention, in the identical function definition generation determining step, when it is determined as a result of analysis that none of the definitions of the plurality of functions includes type conversion depending upon a parameter in a function defining portion thereof, that none of the definitions of the plurality of functions includes a function call using an argument depending upon a template parameter and that there already exists a function definition instantiated with a template parameter with an identical type size, specific parameter identical function information composed of at least a file name, a template function name, a parameter size and an instantiated function name is generated.

In another aspect of the template compilation method of this invention, it is analyzed in the identical function definition generation determining step whether or not any of the definitions of the plurality of functions uses a class template as the template and includes type conversion depending upon a template parameter in a member function defining portion thereof, whether or not any of the definitions of the plurality of functions includes a function call using an argument depending upon a template parameter and whether or not there already exists a function definition instantiated with a template parameter with an identical type size.

In another aspect of the template compilation method of this invention, in the identical function definition generation determining step, when it is determined as a result of analysis that none of the definitions of the plurality of functions includes type conversion depending upon a parameter in a member function defining portion thereof, that none of the definitions of the plurality of functions includes a function call using an argument depending upon a template parameter and that there already exists a function definition instantiated with a template parameter with an identical type size, specific parameter identical function information composed of at least a file name, a template function name, a parameter size and an instantiated function name is generated.

In another aspect of the template compilation method of this invention, the function definition sharing step includes sub-steps of receiving the nondependent function information generated in the identical function definition generation determining step; registering names of instantiated functions generated from an identical template in the nondependent function information with a common function name; and changing function definition codes of the instantiated functions generated from the identical template into a function definition code of the common function definition.

In another aspect of the template compilation method of this invention, the function definition sharing step includes sub-steps of receiving the specific parameter identical function information generated in the identical function definition generation determining step; registering names of instantiated functions generated from an identical template with an identical parameter size in the specific parameter identical function information with a common function name; and changing function definition codes of the instantiated functions generated from the identical template with the identical parameter size into a function definition code of the common function definition.

In another aspect of the template compilation method of this invention, in the function call replacing step, a function call statement using a starting address of a function obtained before generating the common function definition is replaced with a function call statement using a starting address of the common function definition obtained in the function definition sharing step.

In another aspect of the template compilation method of this invention, in the function call replacing step, when the function call is a virtual function call, a starting address of a function obtained before generating the common function definition registered in a virtual function table is replaced with a starting address of the common function definition obtained in the function definition sharing step.

In another aspect of the template compilation method of this invention, in the function call replacing step, when a plurality of virtual function tables attain identical registration contents as a result of replacing the starting address of the function obtained before generating the common function definition registered in the virtual function table with the starting address of the common function definition, the plurality of virtual function tables are replaced with one common virtual function table.

As described above, according to the present invention, it is first determined whether or not identical function definitions are generated among a plurality of function definitions of an input program from a template by using different template parameters. In the case where it is determined as a result that the identical definitions are generated, these identical function definitions are replaced with one common function definition, and calls of these function definitions are replaced with a call of the common function definition.

Accordingly, even when the input program includes a plurality of function definitions generated by giving different parameters to the template, when these plural function definitions are generated as identical definition codes, the identical definition codes corresponding to the plural function definitions are not included in the resultant output codes. As a result, object codes can be generated efficiently with a small code size.

### BRIEF DESCRIPTION OF THE DRAWINGS

FIG. 1 is a diagram of a compilation step in a template compilation method according to an embodiment of the invention;

FIG. 2 is a process flowchart for an identical function definition generation determining step in the compilation step of FIG. 1;

FIG. 3 is a process flowchart for a function definition sharing step in the compilation step of FIG. 1;

FIG. 4 is a process flowchart for a function call replacing step in the compilation step of FIG. 1;

FIG. 5 is a diagram of a program stored in a program storage;

FIG. 6A is a diagram of template information extracted in the identical function definition generation determining step, FIG. 6B is a diagram of parameter nondependent function information generated in the identical function definition generation determining step and FIG. 6C is a diagram of specific parameter identical function information generated in the identical function definition generation determining step;

FIG. 7A is a diagram of name information of function definition that are registered with common function names in the function definition sharing step and FIG. 7B is a diagram of function definition code information in which function definition codes obtained before sharing a common code are deleted and common function definition codes are registered in the function definition sharing step;

FIG. 8A is a diagram of function call information extracted in the function call replacing step and replacement with common functions and FIG. 8B is a diagram of virtual function table information extracted in the function call replacing step and replacement with common functions;

FIG. 9A is a diagram of replacement of a virtual function table with a common virtual function table to be referred to in a virtual call in the function call replacing step and FIG. 9B is a diagram of replacement of the entity of the virtual function table with the common virtual function table in the function call replacing step;

FIG. 10 is a diagram of outputs resulting from employment of the template compilation method of the embodiment of the invention;

FIG. 11 is a diagram of outputs resulting from employment of a conventional compilation method; and

FIG. 12 is a diagram of an exemplified program using templates and resultant output codes.

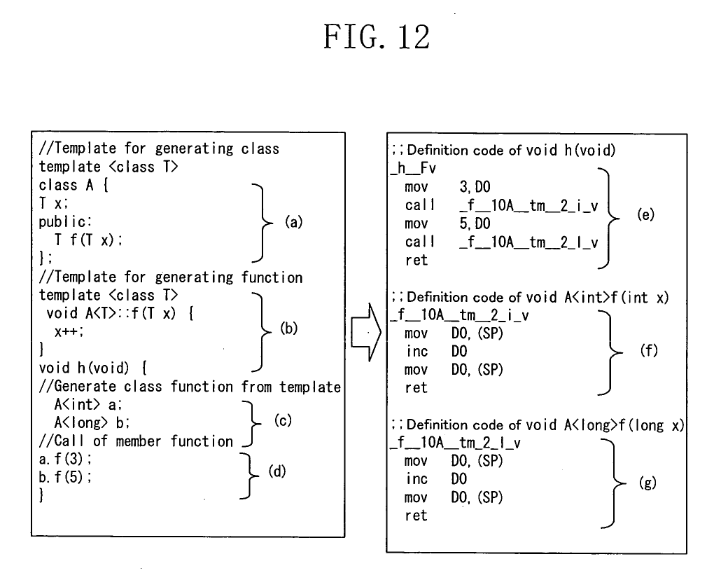

### DETAILED DESCRIPTION OF THE INVENTION

A preferred embodiment of the invention will now be described with reference to the accompanying drawings.

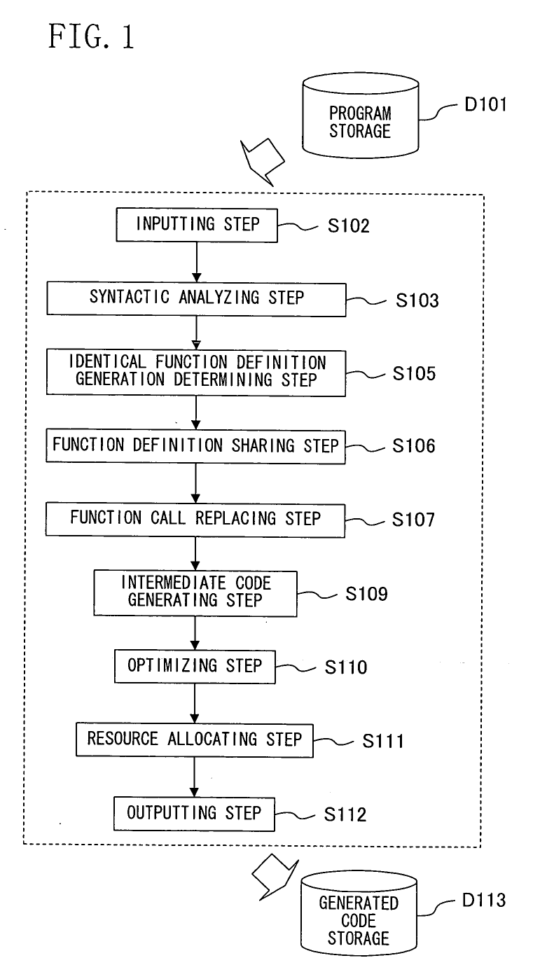

FIG. 1 is a structure chart of a compilation method according to the embodiment of the invention.

The compilation step of FIG. 1 includes an inputting step S102, a syntactic analyzing step S103, an identical function definition generation determining step S105, a function definition sharing step S106, a function call replacing step S107, an intermediate code generating step S109, an optimizing step S110, a resource allocating step S111 and an outputting step S112. The respective steps of the compilation step are processing executed by a compilation apparatus equipped with a CPU on the basis of a compiler.

A program storage D101 stores input programs to be compiled.

In the input step S102, all the programs stored in the program storage D101 are successively input to be passed to the syntactic analyzing step S103.

In the syntactic analyzing step S103, the syntax of each program passed from the input step S102 is analyzed, so as to generate a symbol table, a syntax tree and the like.

In the identical function definition generation determining step S105, information associated with a template is extracted from information generated in the syntactic analyzing step S103, and it is analyzed whether or not identical function definitions are generated from the template by using different template parameters.

In the function definition sharing step S106, information associated with function definition is extracted from the information generated in the syntactic analyzing step S103, the analysis result is passed from the identical function definition generation determining step S105, and a plurality of function definitions generated as the identical function definitions by using different template parameters are replaced with a single common function definition.

In the function call replacing step S107, information associated with function call is extracted from the information generated in the syntactic analyzing step S103, the replacement result is passed from the function definition sharing step S106, and function calls obtained before sharing the common definition are replaced with a call of the common function definition on the basis of the resultant common function definition.

In the intermediate code generating step S109, an intermediate code is generated on the basis of the syntax tree generated in the syntactic analyzing step S103. In generating an intermediate code associated with a function definition generated from the template or a virtual function table, the replaced information obtained through execution of the identical function definition generation determining step S105, the function definition sharing step S106 and the function call replacing step S107 is referred to to generate a corresponding intermediate code.

In the optimizing step S110, various optimization is performed on the intermediate code generated in the intermediate code generating step S1109.

In the resource allocating step S111, hardware resources such as a register and a memory are allocated to all variables included in the intermediate code having been optimized in the optimizing step S110.

In the outputting step S112, the intermediate code having been subjected to the resource allocation in the resource allocating step S111 is converted into an object code, which is output to a generated code storage D113.

The generated code storage D113 stores the object code having been converted through the compilation step including the steps S102 through S112.

The inputting step S102, the syntactic analyzing step S103, the intermediate code generating step S109, the optimizing step S110, the resource allocating step S111 and the outputting step S112 are not herein described in detail because they are not the principal point of the invention.

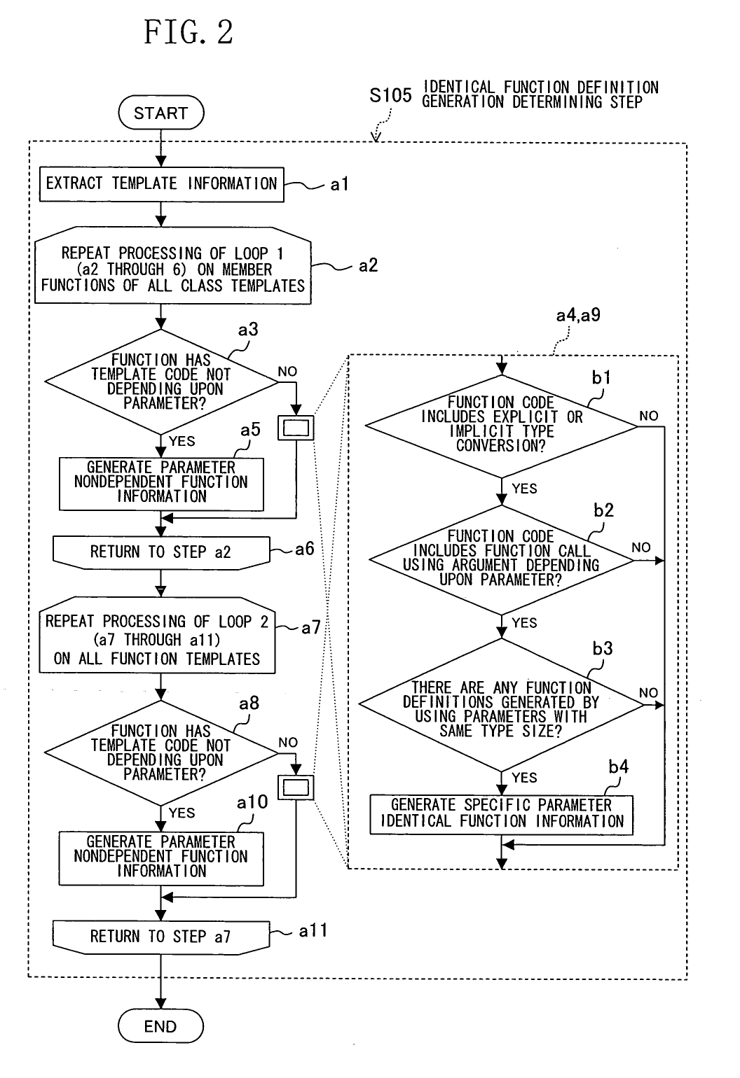

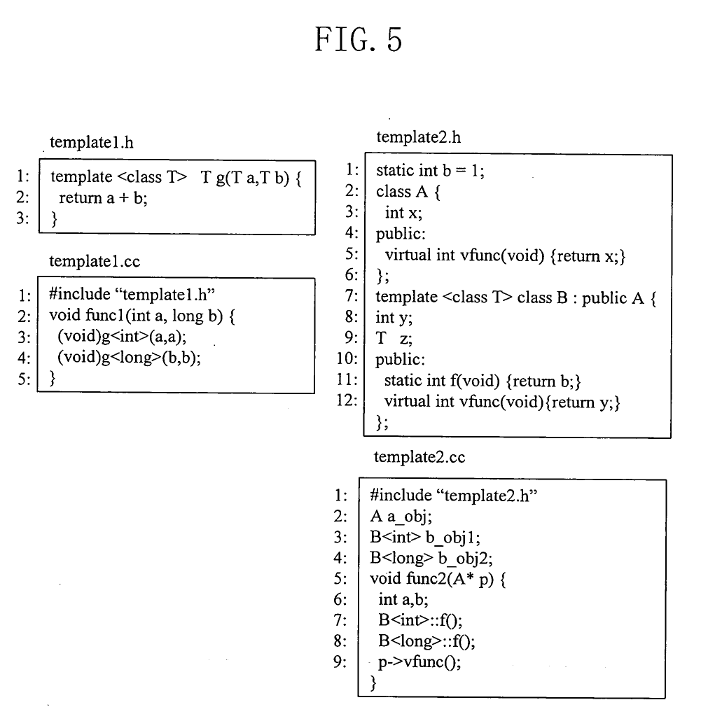

Next, processing of the identical function definition generation determining step S105 will be described with reference to FIG. 2 by exemplifying application to a program shown in FIG. 5.

The processing of the identical function definition generation determining step S105 is performed through steps a1 through all, which will now be described in this order.

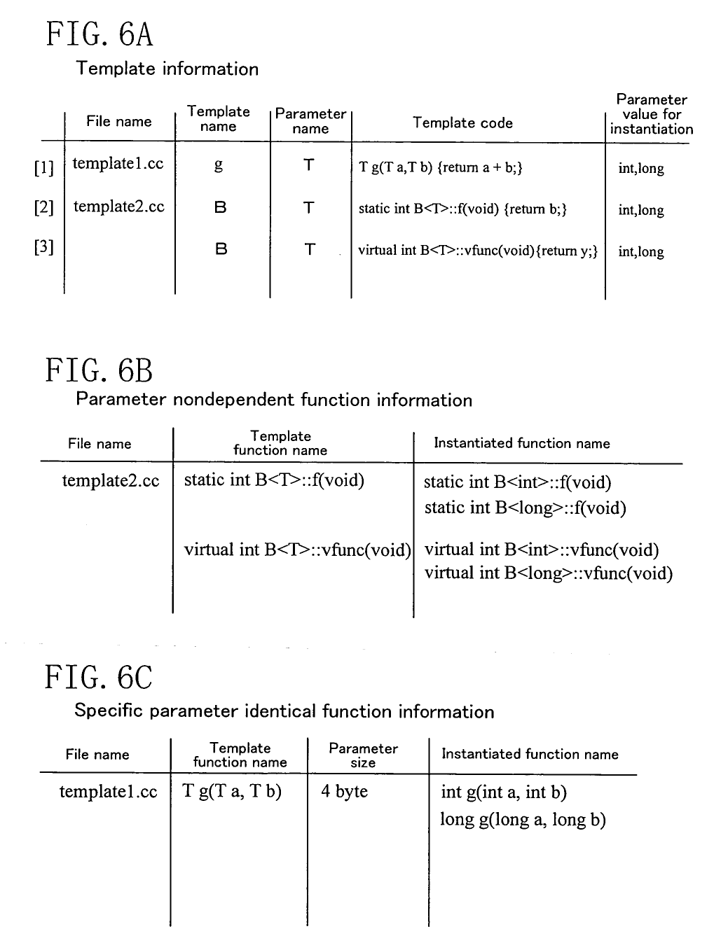

In the step a1, the information associated with a template is extracted from the information generated in the syntactic analyzing step S103. Since information of templates of all the input files has been analyzed in the syntactic analyzing step S103, merely the information associated with templates is extracted. Referring to the program shown in FIG. 5, in all the input files template1.cc and template2.cc, defined templates are a function template g in the file template1.cc and a class template B in the file template2.cc. Therefore, an extraction result as shown in FIG. 6A is obtained. It is noted that the “#include” statement on the first line of the input file template1.cc or template2.cc corresponds to a program for expanding the content of a file enclosed in “ ” in this position.

In the step a2, in the whole extracted information of the templates, processing of a loop 1 (including the steps a2 through a6) is repeatedly performed on respective member functions of each class template. In FIG. 6A, [2] and [3] correspond to the member functions of the class template, and hence, the processing of the loop 1 is repeatedly performed on the member functions [2] and [3].

In the step a3, it is determined whether or not the member function has a template code not depending upon the template parameter at all. When NO, the flow proceeds to the step a4, and when YES, the flow proceeds to the step a5. For example, when the member function [2] of FIG. 6A is subjected to the determination of the step a3, the code of the member function [2] is return b; regardless of the value of the template parameter T and hence does not depend upon the value of the template parameter T at all. Therefore, the determination made in the step a3 is YES, and hence the flow proceeds to the step as.

Also, the code of the member function [3] is return y; regardless of the value of the template parameter T and hence does not depend upon the value of the template parameter T at all. Therefore, the determination made in the step a3 is YES, and hence the flow proceeds to the step as.

In the step a4, it is determined whether or not there is a function from which identical codes are generated with respect to a specific combination of template parameter values. The process of the step a4 is the same as that of the step a9 performed in a loop 2 of the step a7 described below. Since the member functions [2] and [3] of FIG. 6A have been determined as YES in the step a3, these functions are not subjected to the process of the step a4. This process will be described in detail in describing the step a9.

In the step a5, parameter nondependent function information of the member function having been determined as YES in the step a4 is generated. Since the member functions [2] and [3] of FIG. 6A are parameter nondependent functions, the parameter nondependent function information as shown in FIG. 6B composed of at least a file name, a template function name and an instantiated function name made into entity (instantiated) by the template parameter is generated with respect to each of the member functions [2] and [3].

In the step a6, the flow returns to the step a2 so as to repeat the processing of the loop 1.

In the step a7, processing of the loop 2 is repeatedly performed on function templates included in the whole extracted information of the templates. In FIG. 6A, [1] corresponds to a function template. The processing of the loop 2 is executed on the function template [1].

In the step a8, it is determined whether or not the function has a template code not depending upon the template parameter at all. When NO, the flow proceeds to the step a9, and when YES, the flow proceeds to the step a10. When the function template [1]of FIG. 6A is subjected to the determination of the step a8, the code of the function template [1] depends upon the template parameter because the types of virtual arguments a and b are different depending upon the value of the template parameter T. Accordingly, the function template [1] is determined as NO in the step a8, and the flow proceeds to the step a9.

In the step a9, it is determined whether or not there is a function from which identical codes are generated with respect to a specific combination of template parameter values. The process of the step a9 is the same as that of the step a4 performed in the loop 1 of the step a2.

The process of the step a4 and the step a9 is performed through steps b1 through b4, which will now be described in this order.

In the step b1, it is determined whether or not there is explicit or implicit type conversion in the function code. When YES, the flow proceeds to the step b2, and when NO, the flow goes out of the process of the step a4 or the step a9. When the function template [1] of FIG. 6A is subjected to the determination of the step b1, there is no type conversion in the code return a+b; of the function template [1], and therefore, the function template [1] is determined as YES in the step b1, and the flow proceeds to the step b2.

In the step b2, it is determined whether or not there is a function call by using a parameter dependent argument. When YES, the flow proceeds to the step b3, and when NO, the flow goes out of the process of the step a4 or the step a9. When the function template [1] of FIG. 6A is subjected to the determination of the step b2, there is no function call in the code return a+b; of the function template [1], and hence, the function template [1] is determined as YES in the step b2, and the flow proceeds to the step b3.

In the step b3, it is determined whether or not there are function definitions generated by using parameters with the same type size in the instantiated parameter values. When YES, the flow proceeds to the step b4, and when NO, the flow goes out of the process of the step a4 or the step a9. When the function template [1] of FIG. 6A is subjected to the determination of the step b3, instantiated template parameters of the function template [1] are of the int type and the long type. These types have the same size depending upon compilation circumstances. Herein, it is assumed that both of these types have a size of 4 bytes. Since there are function definitions generated by using the parameters with the same type size, the flow proceeds to the step b4.

In the step b4, specific parameter identical function information is generated on the basis of the function definitions having been determined as YES in all the determinations of the steps b1 through b3. The function template [1] of FIG. 6A has been determined as YES in all the determinations of the steps b1 through b3, and identical codes are generated when the template parameter value is int and when it is long. Therefore, the specific parameter identical function information as shown in FIG. 6C composed of at least a file name, a template function name, a parameter size and an instantiated function name is generated with respect to the function template [1].

In the step a10, parameter nondependent function information of the function having been determined as YES in the step a8 is generated. The function template [1] of FIG. 6A has been determined as NO in the step a8, the process of the step a10 is not performed.

In the step all, the flow returns to the step a7, so as to repeatedly perform the processing of the loop 2.

In this manner, when the processing of the identical function definition generation determining step S105 is applied to the program of FIG. 5, the parameter nondependent function information of FIG. 6B and the specific parameter identical function information of FIG. 6C are generated. These resultant information are passed to the function definition sharing step S106.

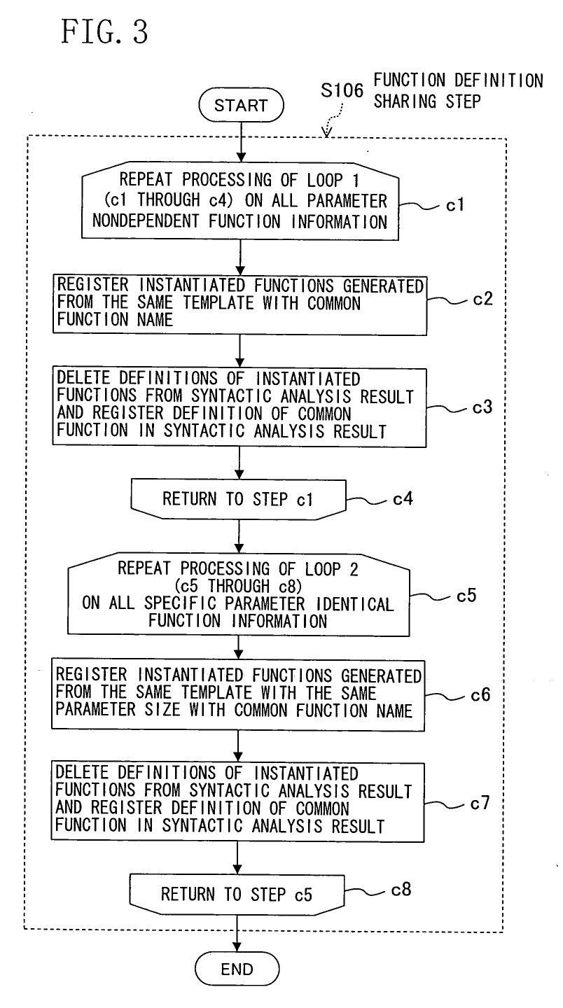

Next, the processing of the function definition sharing step S106 will be described with reference to FIG. 3.

The processing of the function definition sharing step S106 is performed through steps c1 through c8, which will now be described in this order.

In the step c1, in the information passed from the identical function definition generation determining step S105, the parameter nondependent function information is subjected to processing of a loop 1 (including the steps c1 through c4). Specifically, in this embodiment, the processing of the loop 1 is repeatedly performed on the parameter nondependent function information of FIG. 6B.

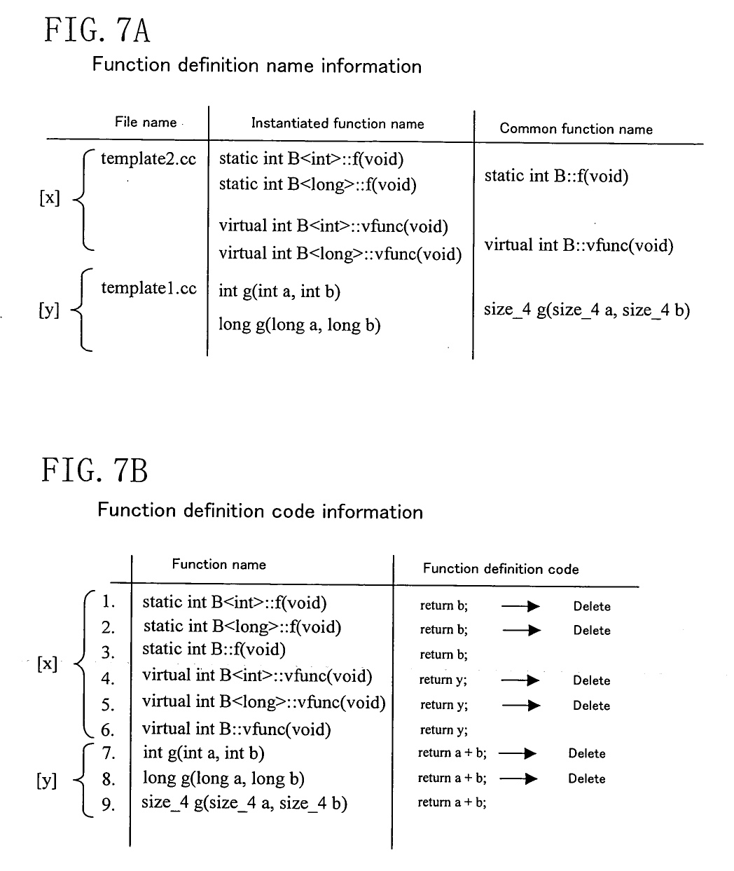

In the step c2, a common function name is registered with respect to the instantiated function names generated from the same template, and the flow proceeds to the step c3. For example, when the parameter nondependent function information of FIG. 6B is subjected to the process of the step c2, a part [x] of FIG. 7A is registered.

In the step c3, the definitions of the respective instantiated functions are deleted from the syntactic analysis result, definition of a common function is registered in the syntactic analysis result, and the flow proceeds to the step c4. When the process of the step c3 is executed on the function definition name information [x] of FIG. 7A, the function definition codes of the instantiated functions are deleted and the function definition code of the common function is newly registered as shown in a part [x] of FIG. 7B.

In the step c4, the flow returns to the step c1, so as to repeat the processing of the loop 1.

In the step c5, in the information passed from the identical function definition generation determining step S105, the specific parameter identical function information is repeatedly subjected to processing of a loop 2 (including the steps c5 through c8). The specific parameter identical function information of FIG. 6C is repeatedly subjected to the processing of the loop 2.

In the step c6, a common function name is registered with respect to instantiated function names generated from the same template by using parameters with the same size, and the flow proceeds to the step c7. When the process of the step c6 is executed on the specific parameter identical function information of FIG. 6C, a part [y] of FIG. 7A is registered.

In the step c7, the definitions of the respective instantiated functions are deleted from the syntactic analysis result, a definition of a common function is registered in a function definition part, and the flow proceeds to the step c8. When the process of the step c7 is executed on the definition name information [y] of the common function shown in FIG. 7A, the function definition codes of the instantiated functions are deleted and the function definition code of the common function is newly registered in the syntactic analysis result as shown in a part [y] of FIG. 7B.

In the step c8, the flow returns to the step c5, so as to repeatedly perform the processing of the loop 2.

In this manner, when the processing of the function definition sharing step S106 is applied to the parameter nondependent function information of FIG. 6B and the specific parameter identical function information of FIG. 6C, the function definition names of FIG. 7A and the function definition codes of FIG. 7B are generated, so as to be passed to the function call replacing step S107.

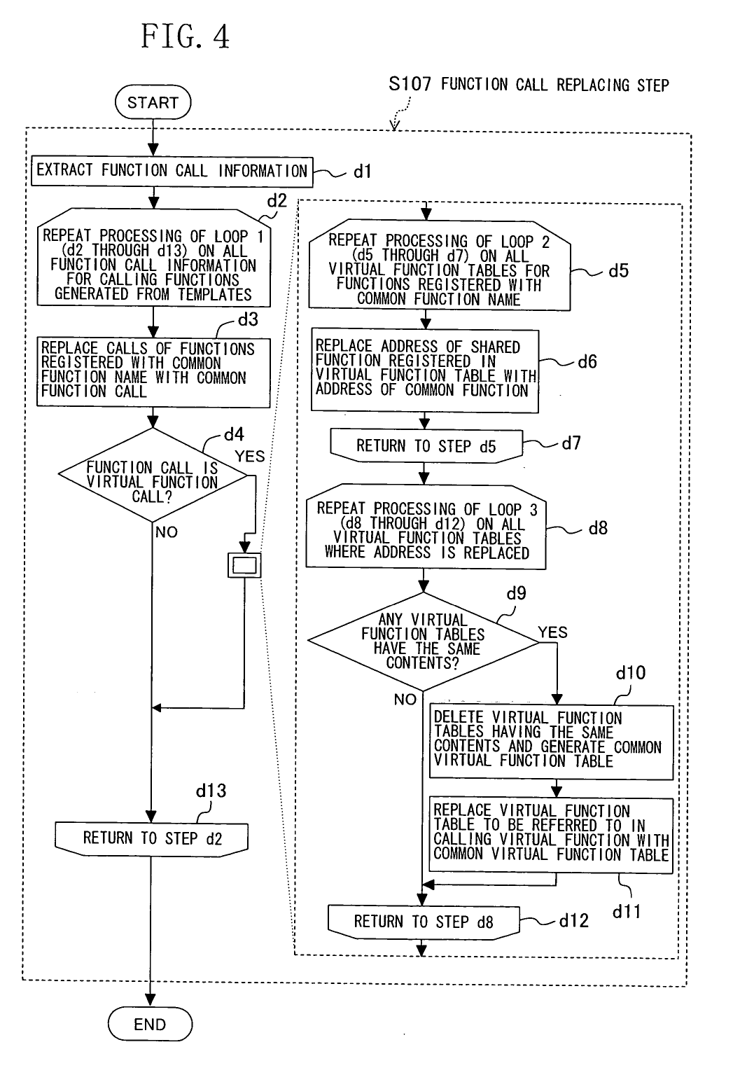

Next, the processing of the function call replacing step S107 will be described with reference to FIG. 4.

The processing of the function call replacing step S107 is performed through steps d1 through d13, which will now be described in this order.

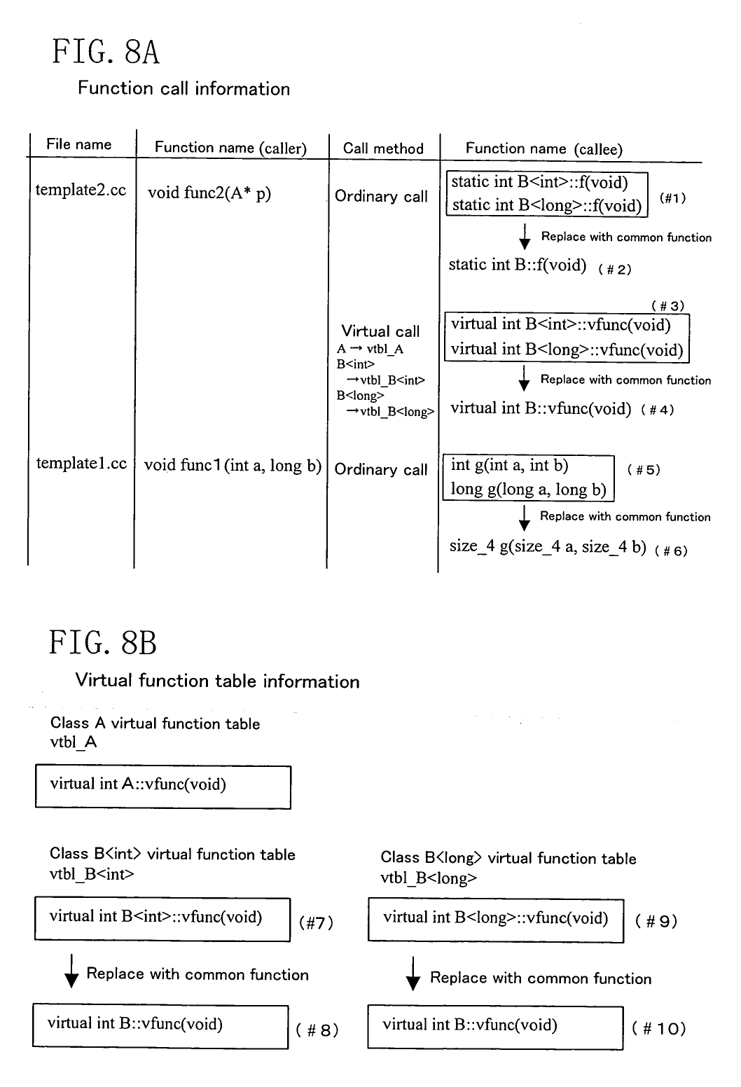

In the step d1, information associated with function calls is extracted from the information generated in the syntactic analyzing step S103. In the case where there is virtual function table information of each class, this information is also extracted. Since the information associated with the function calls included in all the input files has been analyzed in the syntactic analyzing step S103, merely the information associated with function calls and the virtual function table information are extracted. In the program shown in FIG. 5, a function func1 calls the function generated from the template in the file template1.cc, and a function func2 calls the member function of the class generated from the template in the file template2.cc. Therefore, extraction result for the function call information as shown in FIG. 8A is obtained. Also, in the function func2, a virtual function call of a class inherited in the class A is performed, and hence, extraction result for the virtual function table information as shown in FIG. 8B is obtained.

In the step d2, processing of a loop 1 is repeatedly performed on the whole function call information for calling functions generated from the templates. In FIG. 8A, the functions generated from the templates are called in both the functions func1 and func2, and hence, the processing of the loop 1 is repeatedly executed on these functions.

In the step d3, a call of a function whose common function name has been registered is replaced with a common function call. In FIG. 8A, a function call with a reference mark (#1) is replaced with a common function call with a reference mark (#2), a function call with a reference mark (#3) is replaced with a common function call with a reference mark (#4), and a function call with a reference mark (#5) is replaced with a common function call with a reference mark (#6).

In the step d4, it is determined whether or not the function call is a virtual function call. When YES, the flow proceeds to the step d5, and when NO, the flow proceeds to the step d13. In FIG. 8A, the function call with the reference mark (#4) is a virtual function call, and hence the flow proceeds to the step d5. Also, since the function calls with the reference marks (#2) and (#6) are ordinary calls, the flow proceeds to the step d13.

In the step d5, the processing of the loop 2 is repeatedly executed on all virtual function tables in which functions are registered with a common function name. In FIG. 8B, the processing of the loop 2 is repeatedly performed on a virtual function table of a class B<int> and a virtual function table of a class B<long>.

In the step d6, the functions registered with the common function name in the virtual function table are replaced with a common function. An address of the function is actually registered, but it is herein described for simplification that the function is registered. In FIG. 8B, with respect to functions registered with reference marks (#7) and (#9), common function names have been registered in the function definition sharing step S106, and therefore, these functions are respectively replaced with common functions as shown with reference marks (#8) and (#10).

In the step d7, the flow returns to the step d5, so as to repeat the processing of the loop 2.

In the step d8, processing of a loop 3 is repeatedly performed on the virtual function tables in which the functions have been replaced. In FIG. 8B, the processing of the loop 3 is repeatedly performed on virtual function tables vtbl_B<int> and vtbl_B<long>.

In the step d9, it is determined whether or not any virtual function tables have attained the same contents through the replacement performed in the step d6. When YES, the flow proceeds to the step d10, and when NO, the flow proceeds to the step d12. In FIG. 8B, the virtual function tables vtbl_B<int> and vtbl_B<long> have attained the same registration contents, and hence, the flow proceeds to the step d10.

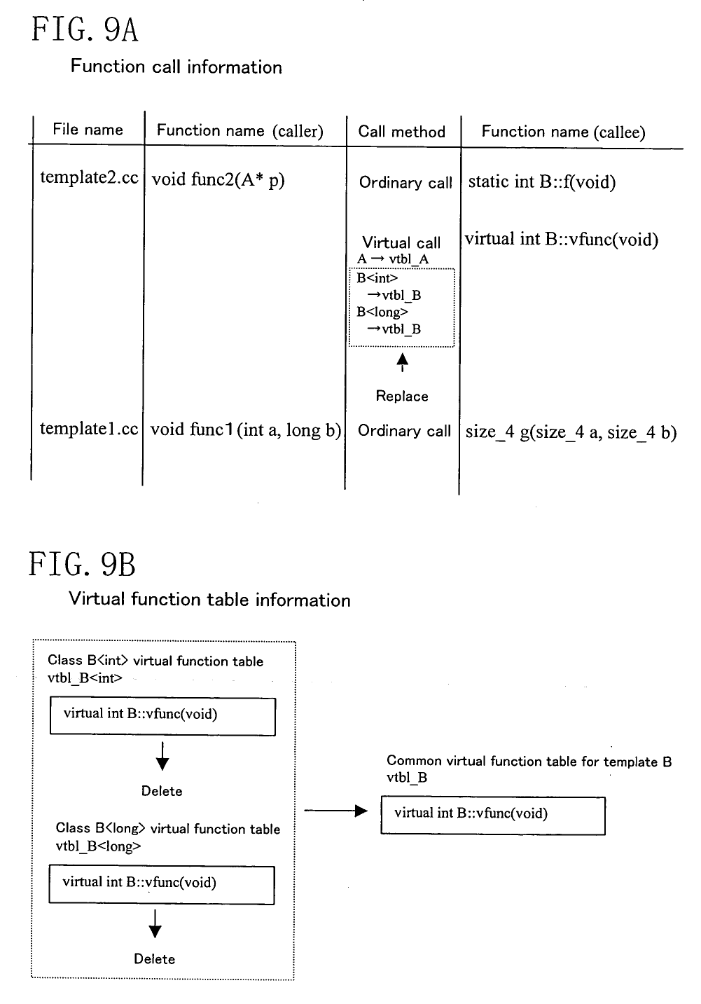

In the step d10, the virtual function tables having the same contents are deleted, and a common virtual function table is generated. The virtual function tables vtbl_B<int> and vtbl_B<long> of FIG. 8B are deleted and a common virtual function table vtbl_B is newly generated as shown in FIG. 9B.

In the step d11, a virtual function table to be referred to in a virtual function call is replaced with a common virtual function table. The virtual function tables vtbl_B<int> and vtbl_B<long> referred to in the virtual calls in FIG. 8A are replaced with the common virtual function table vtbl_B as shown in FIG. 9A.

In the step d12, the flow returns to the step d8, so as to repeat the processing of the loop 3.

In this manner, when the processing of the identical call replacing step S107 is applied to the program shown in FIG. 5, the function call information of FIG. 9A and the virtual function table information of FIG. 9B are generated.

In the intermediate code generating step S109, not only the syntax analysis data generated in the syntactic analyzing step S103 but also data newly generated through the identical function definition determining step S105, the function definition sharing step S106 and the function call replacing step S107 are all read, so as to generate object codes to be ultimately stored in the generated code storage D113.

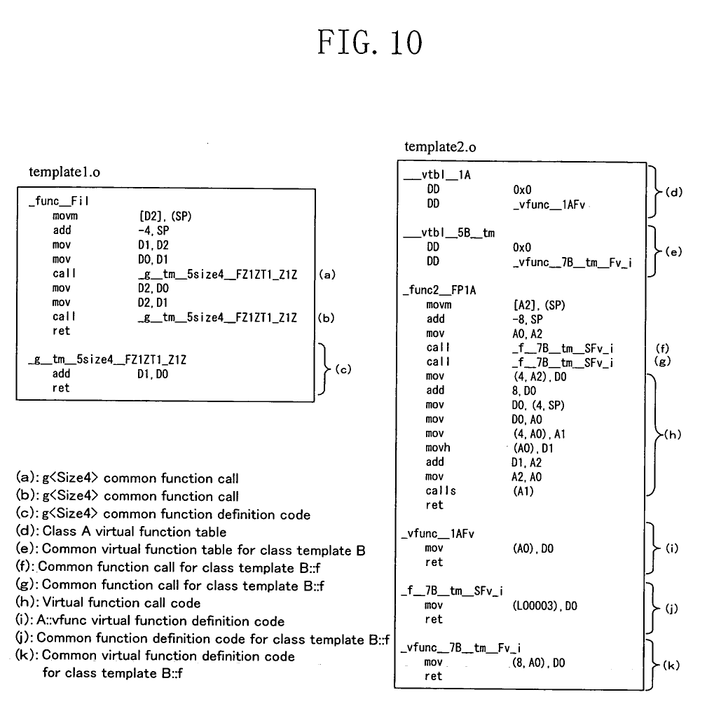

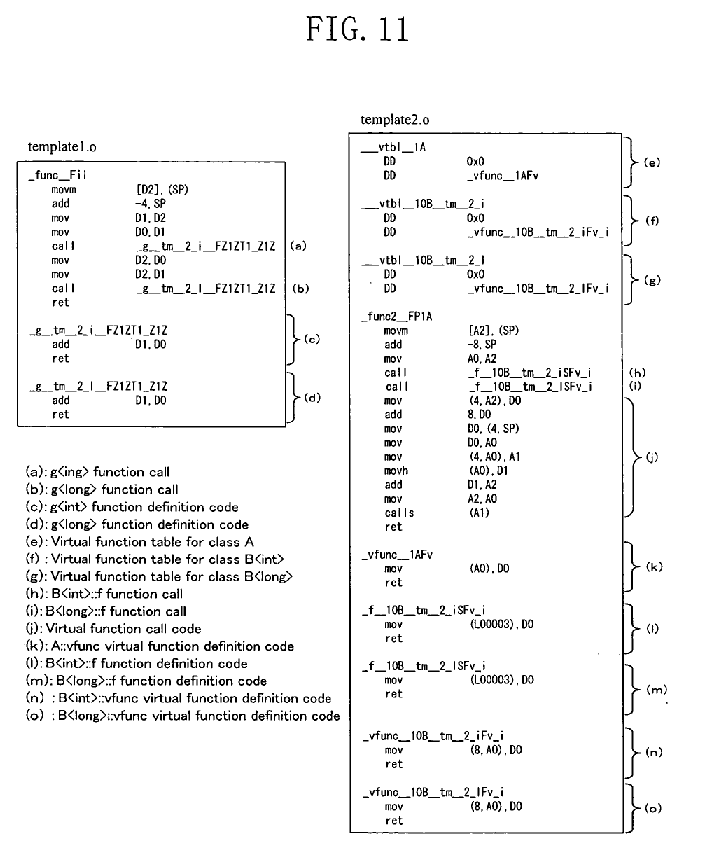

FIG. 10 shows output codes obtained as a result of application of the compilation step of this embodiment to the program of FIG. 5 in the aforementioned manner. Also, for comparison, FIG. 11 shows output codes obtained as a result of conventional compilation. It is understood from these drawings that overlapped codes, such as codes (c) and (d), (f) and (g), (l) and (m), and (n) and (o) of FIG. 11, are changed into common codes (c), (e), (j) and (k) of FIG. 10 through the application of the compilation step of this embodiment. Thus, by employing the compilation step of this embodiment, object codes can be generated efficiently with small code sizes and with a small number of execution steps when identical codes are generated by giving different parameters to a template.

As described so far, even in the case where there are a plurality of function definitions resulting from different parameters given to a template in an input program, when identical definition codes are generated as the plural function definitions, resultant output codes include one identical definition code alone according to the present invention. Therefore, the invention is useful as a template compilation method or the like for efficiently generating output codes with a small code size.

1. A template compilation method for converting an input program described with a high-level language with template facilities into object codes, comprising:
an identical function definition generation determining step of determining whether or not identical function definitions are generated, as definitions of a plurality of functions included in said input program, from a template by using different template parameters;
a function definition sharing step, performed when it is determined that the identical function definitions are generated in the identical function definition generation determining step, of replacing said definitions of said plurality of functions generated as the identical function definitions with one common function definition; and
a function call replacing step, performed when said common function definition is replaced in the function definition sharing step, of replacing calls of said plurality of functions obtained before replacing said common function definition with a call of said common function definition.

2. The template compilation method of claim 1,
wherein it is analyzed in the identical function definition generation determining step whether or not any of said definitions of said plurality of functions uses a function template as said template and includes a portion depending upon a template parameter in a function defining portion thereof.

3. The template compilation method of claim 2,
wherein in the identical function definition generation determining step, when it is determined as a result of analysis that any of said definitions of said plurality of functions using a function template as said template includes no portion depending upon a template parameter in the function defining portion thereof, nondependent function information composed of at least a file name, a template function name and an instantiated function name is generated.

4. The template compilation method of claim 1,
wherein it is analyzed in the identical function definition generation determining step whether or not any of said definitions of said plurality of functions uses a class template as said template and includes a portion depending upon a template parameter in a member function defining portion thereof.

5. The template compilation method of claim 4,
wherein in the identical function definition generation determining step, when it is determined as a result of analysis that any of said definitions of said plurality of functions using a class template as said template includes no portion depending upon a template parameter in the member function defining portion thereof, nondependent function information composed of at least a file name, a template function name and an instantiated function name is generated.

6. The template compilation method of claim 1,
wherein it is analyzed in the identical function definition generation determining step whether or not any of said definitions of said plurality of functions uses a function template as said template and includes type conversion depending upon a template parameter in a function defining portion thereof, whether or not any of said definitions of said plurality of functions includes a function call using an argument depending upon a template parameter, and whether or not there already exists a function definition instantiated with a template parameter with an identical type size.

7. The template compilation method of claim 6,
wherein in the identical function definition generation determining step, when it is determined as a result of analysis that none of said definitions of said plurality of functions includes type conversion depending upon a parameter in a function defining portion thereof, that none of said definitions of said plurality of functions includes a function call using an argument depending upon a template parameter and that there already exists a function definition instantiated with a template parameter with an identical type size, specific parameter identical function information composed of at least a file name, a template function name, a parameter size and an instantiated function name is generated.

8. The template compilation method of claim 1,
wherein it is analyzed in the identical function definition generation determining step whether or not any of said definitions of said plurality of functions uses a class template as said template and includes type conversion depending upon a template parameter in a member function defining portion thereof, whether or not any of said definitions of said plurality of functions includes a function call using an argument depending upon a template parameter and whether or not there already exists a function definition instantiated with a template parameter with an identical type size.

9. The template compilation method of claim 8,
wherein in the identical function definition generation determining step, when it is determined as a result of analysis that none of said definitions of said plurality of functions includes type conversion depending upon a parameter in a member function defining portion thereof, that none of said definitions of said plurality of functions includes a function call using an argument depending upon a template parameter and that there already exists a function definition instantiated with a template parameter with an identical type size, specific parameter identical function information composed of at least a file name, a template function name, a parameter size and an instantiated function name is generated.

10. The template compilation method of claim 3,
wherein the function definition sharing step includes sub-steps of:
receiving said nondependent function information generated in the identical function definition generation determining step;
registering names of instantiated functions generated from an identical template in said nondependent function information with a common function name; and
changing function definition codes of said instantiated functions generated from the identical template into a function definition code of said common function definition.

11. The template compilation method of claim 7,
wherein the function definition sharing step includes sub-steps of:
receiving said specific parameter identical function information generated in the identical function definition generation determining step;
registering names of instantiated functions generated from an identical template with an identical parameter size in said specific parameter identical function information with a common function name; and
changing function definition codes of said instantiated functions generated from the identical template with the identical parameter size into a function definition code of said common function definition.

12. The template compilation method of claim 1,
wherein in the function call replacing step, a function call statement using a starting address of a function obtained before generating said common function definition is replaced with a function call statement using a starting address of said common function definition obtained in the function definition sharing step.

13. The template compilation method of claim 1,
wherein in the function call replacing step, when a function call is a virtual function call, a starting address of said function obtained before generating said common function definition registered in a virtual function table is replaced with a starting address of said common function definition obtained in the function definition sharing step.

14. The template compilation method of claim 13,
wherein in the function call replacing step, when a plurality of virtual function tables attain identical registration contents as a result of replacing said starting address of said function obtained before generating said common function definition registered in said virtual function table with said starting address of said common function definition, said plurality of virtual function tables are replaced with one common virtual function table.

15. The template compilation method of claim 5,
wherein the function definition sharing step includes sub-steps of:
receiving said nondependent function information generated in the identical function definition generation determining step;
registering names of instantiated functions generated from an identical template in said nondependent function information with a common function name; and
changing function definition codes of said instantiated functions generated from the identical template into a function definition code of said common function definition.

16. The template compilation method of claim 9,
wherein the function definition sharing step includes sub-steps of:
receiving said specific parameter identical function information generated in the identical function definition generation determining step;
registering names of instantiated functions generated from an identical template with an identical parameter size in said specific parameter identical function information with a common function name; and
changing function definition codes of said instantiated functions generated from the identical template with the identical parameter size into a function definition code of said common function definition.
